(19) United States
(12) Patent Application Publication
(10) Pub. No.: US 2025/0017184 A1
(43) Pub. Date: Jan. 16, 2025

(54) Fishing Hook Guard

(71) Applicant: Keith Berg, Parkland County (CA)

(72) Inventor: Keith Berg, Parkland County (CA)

(21) Appl. No.: 18/351,586

(22) Filed: Jul. 13, 2023

(51) Int. Cl. A01K 83/00

(52) U.S. Cl. CPC A01K 83/066

(57) ABSTRACT

A fishing hook guard is provided. The fishing hook guard includes two or more shells that can be coupled together to enclose a hook of a fishing implement. Each shell features a centrally aligned half aperture, forming a complete aperture when joined in a closed configuration. In the closed configuration, the shells are secured via a fastener, creating a closed guard with a flat disk and a sidewall extending from one side. The combined sidewall and disk form an open cylinder for accommodating the fishing hook. When opened, the shells separate, exposing the fishing hook.

### BACKGROUND OF THE INVENTION

The present invention relates to a fishing hook guard. More specifically, the present invention relates to a fishing hook guard that encloses a fishing hook to prevent the hook from catching or otherwise damaging other objects.

Anglers commonly use fishhooks of different sizes and configurations depending on their target species and fishing techniques. However, one persistent issue with fishing hooks is that they are often exposed, leading to potential hazards such as injuries, entanglement, and damage to fishing equipment. It is a common concern among anglers that exposed fishhooks pose a significant risk of injury. Accidental contact with a fishhook can result in painful punctures and potential infections.

Additionally, the storage and organization of fishhooks can be challenging, especially when multiple hooks are used in a fishing rig. In traditional tackle boxes or containers, fishhooks are often stored together without adequate separation, leading to entanglement and potential damage to the hooks.

There exists some techniques and devices that assist with the entanglement of hooks and seek to minimize the dangers of fishhooks. For example, some known art exists that include shields that receive the hook portion of the fishhooks to prevent the hook portion from snagging other objects. However, these devices introduce other issues such as increasing the likelihood of damaging the hooks. Moreover, these devices prevent the hooks from properly drying and can lead to rust. Another approach involves the use of separate hook covers or caps to enclose individual fishhooks. While these covers offer some protection, they can be easily misplaced or lost, and do not address the issue of organizing multiple hooks attached to a lure or fishing rig. Furthermore, some anglers resort to removing fishhooks from the lure altogether when not in use. However, this practice is time-consuming and increases the risk of losing or misplacing the hooks, leading to inconvenience and decreased efficiency during fishing trips.

The current invention overcomes these deficiencies by introducing a new fishing hook guard that encloses the fishhook, making it safe from sticking into people, clothing, or any object that the hook would usually get stuck on. This provides a significant improvement in safety for both anglers and those in close proximity to fishing activities. Additionally, the open lower end allows for water to drain from the guard and prevent the hooks from rusting.

In light of the devices disclosed in the known art, it is submitted that the present invention substantially diverges in design elements and methods from the known art and consequently it is clear that there is a need in the art for an improvement for a fishing hook protector that protects the hook and is easily secure to the fishing lure or implement. In this regard the instant invention substantially fulfills these needs.

### SUMMARY OF THE INVENTION

In view of the foregoing disadvantages inherent in the known types of fishing hook guards. The present invention provides a new device for enclosing the fishing hook to prevent unintended snagging of users and objects while protecting the hooks from damage.

It is an objective of the present invention to provide an embodiment of the fishing hook guard that comprises of two or more shells coupled together to enclose around a hook of a fishing implement. When enclosed, the guard prevents the hooks from contacting other objects within the shells.

It is another objective of the present invention to provide an embodiment of the fishing hook guard where each shell includes a centrally aligned half aperture, forming a complete aperture when coupled together, allowing the shank of a fishing hook to pass through. In this way, the present invention provides for the closure of the guard around the hooks without requiring the removal of the hooks from the fishing implement, such as a lure.

It is yet another objective of the present invention to provide an embodiment of the fishing hook guard that can be fastened in a closed configuration using a suitable fastener, creating a closed guard with a flat disk and a sidewall extending from one side of the disk.

It is yet another objective of the present invention to provide an embodiment of the fishing hook guard wherein the sidewall terminates at a fixed distance from the disk, forming an open lower end opposite the disk and creating a coextensive exterior surface.

It is an objective of the present invention to provide an embodiment of the fishing hook guard where the combined sidewall and disk form an open cylinder with an interior volume that is sized to entirely receive and enclose the hooks of the fishing implement.

It is an objective of the present invention to provide an embodiment of the fishing hook guard that can be separated into an open configuration, allowing for easy removal of the fishing implement and convenient access to the enclosed fishing hook.

It is an objective of the present invention to provide a fish hook guard that is utilized for safeguarding hooks during packaging and storage. The fish hook guard allows customers to select hooks without being injured and protects the hooks from damage by contacting other hooks or items during storage and shipment.

It is therefore an object of the present invention to provide a new and improved fishing hook guard for safely enclosing and protecting fishing hooks, enhancing convenience, and facilitating efficient storage and transportation of fishing implements.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fishing hook guard connected to a fishing lure.

FIG. 2 shows an overhead view of an embodiment of the fishing hook guard connected to a fishing lure.

FIG. 3 shows an exploded view of an embodiment of the pair of shells of the fishing hook guard.

### DETAILED DESCRIPTION OF THE INVENTION

Reference is made herein to the attached drawings. Like reference numerals are used throughout the drawings to depict like or similar elements of the system. For the purposes of presenting a brief and clear description of the present invention, the preferred embodiment will be discussed as used for enclosing around a fishing hook of a fishing lure. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment”, “second embodiment”, or “third embodiment” does not necessarily refer to the same embodiment.

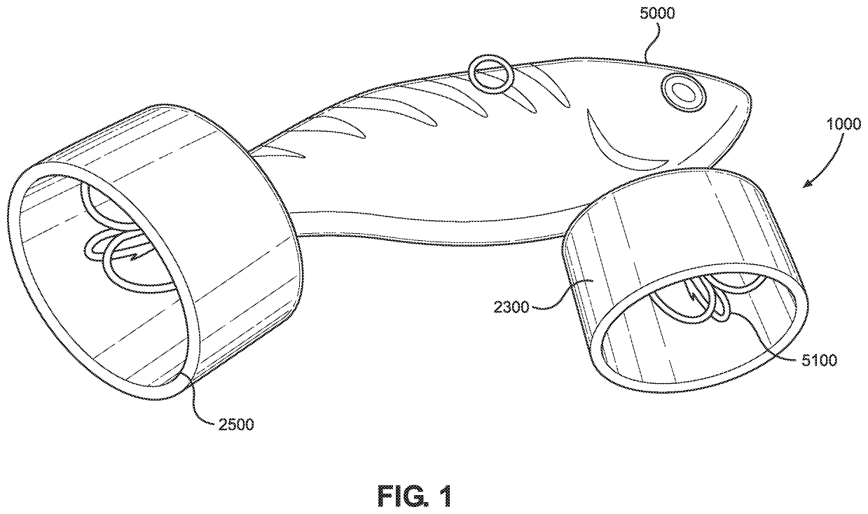

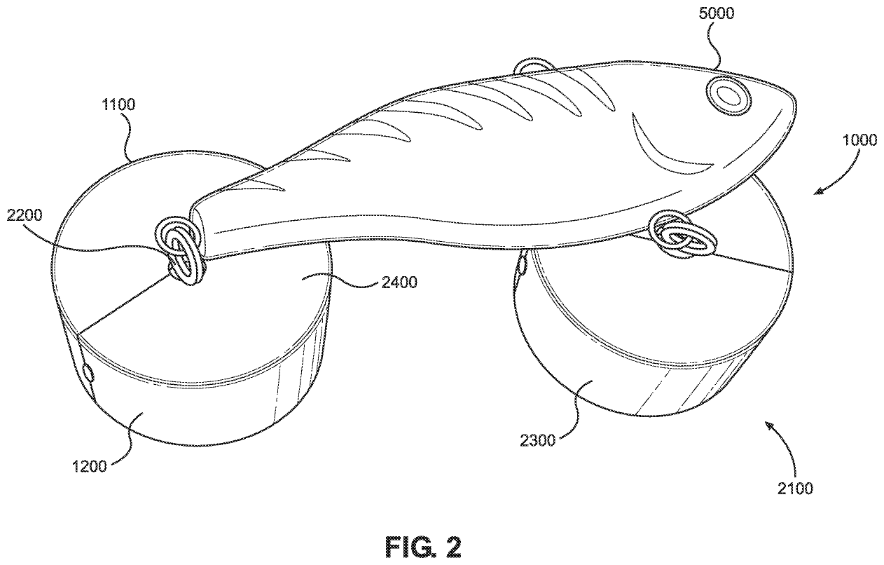

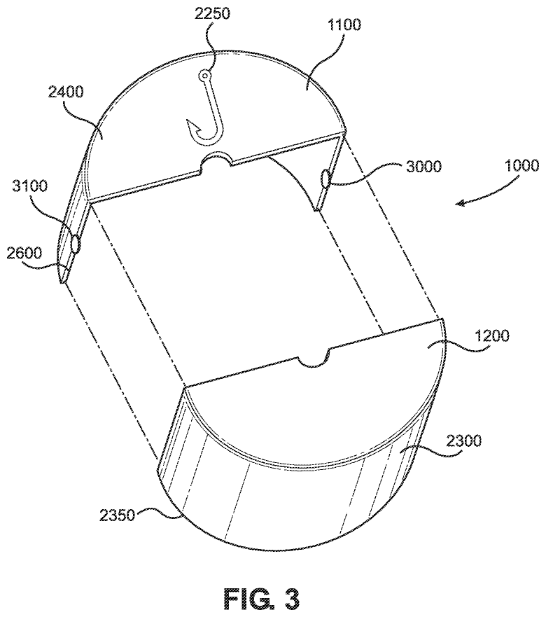

Referring now to FIGS. 1 and 2, there is shown a perspective and overhead view of an embodiment of the fishing hook guard connected to a fishing lure, respectively. The fishing hook guard 1000 is adapted to secure to a hook 5100 of a fishing implement 5000, such as a fishing lure with one or more hook. In the shown embodiment, the hook guard 1000 comprises two or more shells 1100, 1200 that are adapted to couple together forming a secure enclosure (closed guard 2100) for housing the hook 5100. Each shell 1100, 1200 includes a partial aperture 1400 (best shown in FIG. 3), and when the shells 1100, 1200 are coupled, the half apertures 1400 align to form a complete aperture 2200. The size of the complete aperture is suitable for the passage of a fishing hook shank thereby ensuring a proper fit and secure placement. In some embodiments, the complete aperture is formed on one or both of the shells 1100, 1200. In this way, multiple hooks may be secured by the closed guard 2100. In other embodiments, one shell comprises the aperture or a cutout along an interior edge thereof and the adjoining shell comprises a linear edge that encloses the aperture or cutout when the shells are coupled together. In some embodiments, a pair of shells each comprise a partial aperture having different sizes, but when joined, form a complete aperture. In the shown embodiment, the partial aperture is a half aperture. In some embodiments, having a shell with a larger aperture provides a larger area to retain the hook until the adjoining shell is coupled thereto.

In the shown embodiment, when the two or more shells 1100, 1200 are coupled together, a closed guard 2100 is formed. The closed guard 2100 forms a flat disk 2400 with the complete aperture 2200 positioned generally centrally. In the shown embodiment, the disk 2400 is annular, however in alternative embodiments, the disk 2400 may have other shapes and dimensions such as rectangular, oval, and the like. The complete aperture 2200 is sized to receive a shank of the hook 5100 such that the barb is positioned within the enclosure and the eye of the hook is positioned outside the enclosure. The complete aperture 2200 is also sized to prevent the barb from sliding through the aperture 2200 thereby preventing the hook from exiting the closed guard 2100.

In one embodiment, a sidewall 2300 extends from the perimeter 2210 of the disk 2400 which cooperatively forms an open cylinder. The open cylinder created by the sidewall 2300 and disk 2400 has an interior volume sized to entirely receive and enclose the hook 5100 of the fishing implement 5000. This prevents snapping of other objects such as other hooks, cloths, hands, and the like. In the shown embodiment, the sidewall 2300 terminates at a fixed distance from the disk 2300, resulting in an open lower end 2500 opposite the disk 2400. This open lower end 2500 allows for moisture of the hook 5100 to drip off the hook or otherwise evaporate. In this way, the hook guard 1000 minimizes rust buildup on the hook 5100. In one embodiment, the sidewall is extended to fit a larger and longer hook.

In the shown embodiment, the sidewall 2300 and disk 2400 form a coextensive exterior side thereby creating a streamlined and aesthetically pleasing appearance. The sidewall 2300 and disk 2400 may be integrally made from a single piece of extruded and molded plastic. In alternative embodiments, the hook guard 1000 is constructed from metal or foam. In yet another embodiment, the hook guard 1000 is constructed from a flexible material, such as rubber. In some embodiments, the hook guard 1000 is sized to house multiple hooks and/or have multiple apertures off center.

Referring now to FIG. 3, there is shown an exploded view of an embodiment of the pair of shells of the fishing hook guard. In the shown embodiment, each shell 1100, 1200 is adapted to couple with the opposing shell to form the hook guard 1000. A fastener 3000, 3100 is positioned on a lateral side edge 2600 of each shell 1100, 1200. In the shown embodiment, the fasteners 3000, 3100 are tab and slot fasteners adapted to frictionally interlock and hold the shells 1100, 1200 together. In alternative embodiments, any suitable fastener may be utilized to hold the shells 1100, 1200 together. In one embodiment, the fastener 3000, 3100 is magnetic.

In operation, when the fishing hook guard 1000 is in the closed configuration, the two or more shells 1100, 1200 are coupled together forming a secure enclosure for the hook 5100 of the fishing implement 5000. The shank of the fishing hook 5100 is positioned through one of the half apertures 1400, and the shells are fastened using the fastener 3000, 3100 such that the other partial aperture 1400 forms a complete aperture. In one embodiment, a lower edge 2350 of each shell 1100, 1200 is flat and configured to rest atop a horizontal surface such that the sidewall 2300 is perpendicular thereto.

In an open configuration, the fastener 3000, 3100 is released, allowing the two or more shells 1100, 1200 to separate. This enables easy removal of the fishing hook 5100. Should one of the shells 1100, 1200 be damaged, a third shell may be interchanged with either the first or second shell 1100, 1200 and still be configured to fasten to the opposing first or second shell 1100, 1200 respectively. In this way, wherein each shell 1100, 120 are similar and usable with other similar shell.

In one embodiment, an advertisement section 2250 is disposed on the disk 2400, wherein the advertising section 2250 is disposed on a single shell 1100. In an alternative embodiment, the advertisement section is disposed on the sidewall 2300 or a combination of disc 2400 and sidewall 2300.

In one embodiment, the hook guard 1000 and corresponding shells 1100, 1200 may be available in various sizes to accommodate corresponding fishing hook sized. For example, a small, medium, and large hook guard 1000 may be available to fit size 4/0, 3/0, and 2/0. In one embodiment, the complete aperture is configured to receive only one shank.

In one embodiment the hook guard 1000 is adapted to protect the hook and users during packaging and storage. When the hook guard is utilized for packaging purposes, it acts as a barrier that encloses the fishing hook securely within its two or more shells. This protective enclosure prevents accidental contact with the hook, reducing the risk of injuries and damage during handling, transportation, and storage. The hook guard 1000 is particularly useful for manufacturers and distributors who package fishing hooks in bulk quantities. By enclosing each individual hook within its own guard, the hooks remain protected and separated from one another, preventing entanglement and damage. Furthermore, retailers can benefit from the hook guard 1000 when displaying packaged fishing hooks on store shelves. The guard not only maintains the safety of the hooks but also provides a visually appealing and organized presentation. Customers can easily inspect the hooks without the risk of accidental injuries.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing hook guard, comprising:
two or more shells adapted to couple to each other and enclose around a hook of a fishing implement;
wherein each shell includes a partial aperture so as to form an aperture when coupled together sized to receive a fishing hook shank therethrough;
wherein a closed configuration, the two or more shells are coupled via a fastener to form a closed guard, the closed guard comprising:
a flat annular disk having the aperture therethrough;
a sidewall extending from a first side of the disk and terminates at a fixed distance from the disk forming an open lower end opposite the disk;
wherein the sidewall forms a coextensive exterior surface;
wherein the sidewall and disk forms an open cylinder having an interior volume sized to entirely receive the hook therein.

2. The fishing hook guard of claim 1, wherein an open configuration, the two or more shells are separated from each other thereby allowing for the removal of the hook of the fishing implement.

3. The fishing hook guard of claim 1, wherein the partial aperture is centrally aligned.

4. The fishing hook guard of claim 3, wherein the flat disc comprises an advertising section.

5. The fishing hook guard of claim 4, wherein the advertising section is disposed on a single shell.

6. The fishing hook guard of claim 3, wherein a lower edge of each shell is flat and configured to rest atop a horizontal surface such that the sidewall is perpendicular thereto.

7. The fishing hook guard of claim 3, wherein each shell is comprised from a single integral member.

8. The fishing hook guard of claim 3, wherein the fastener is disposed on a lateral edge of the sidewall, wherein the lateral edge of the sidewall faces outwards.

9. The fishing hook guard of claim 8, wherein the fastener includes a corresponding tab and slot.

10. The fishing hook guard of claim 8, wherein each shell is adapted identical such that a third shell may be interchanged with a first shell and still be configured to fasten to the second shell.

11. The fishing hook guard of claim 1, wherein a length of the sidewall is shorter than a diameter of the closed guard.

12. The fishing hook guard of claim 1, wherein the aperture comprises a diameter sized to receive a only single shank of the hook.

13. The fishing hook guard of claim 1, further comprising a second fishing hook guard to secure around a second hook of the fishing implement.
